(19) United States
(12) Patent Application Publication
(10) Pub. No.: US 2026/0220171 A1
(43) Pub. Date: Jul. 30, 2026

(54) METHOD AND SYSTEM FOR QUESTION-ANSWER COMBINATION GENERATION AND USE

(71) Applicant: Verizon Patent and Licensing Inc., Basking Ridge, NJ (US)

(72) Inventors: Sheikbharith Liakathali, Frisco, TX (US); Dennis Thomas, Wyile, TX (US); Rajat Sharma, Southlake, TX (US); Jon D. Hilkert, Benton, AR (US)

(21) Appl. No.: 19/038,564

(22) Filed: Jan. 27, 2025

(51) Int. Cl. G06F 16/3329; G06F 40/30; H04L 51/02

(52) U.S. Cl. CPC G06F 16/33295; G06F 40/30; H04L 51/02

(57) ABSTRACT

One or more computing devices, systems, and/or methods are provided. In some examples, a set of content items may be identified. Intent labels associated with the set of content items and/or sentiments associated with the set of content items may be determined. A first language model may be used to generate a set of question-answer combinations based upon the intent labels and/or the sentiments. A first question-answer combination of the set of question-answer combinations may include a first question and a first answer to the first question. A second language model may be fine-tuned based upon the set of question-answer combinations to generate a fine-tuned language model. A query may be received from a client device. A response to the query may be generated using the fine-tuned language model.

### BACKGROUND

A chatbot may be used to conduct conversations (e.g., chat conversations) with users. For example, the chatbot may use a generative artificial intelligence (AI) tool to generate responses to user queries.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for generating question-answer combinations and/or fine-tuning a language model, where a content preparation module provides content item data indicative of a set of content items, according to some embodiments.

FIG. 1B is a diagram illustrating an example system for generating question-answer combinations and/or fine-tuning a language model, where a content processing module processes content item data to generate processed content item data, according to some embodiments.

FIG. 1C is a diagram illustrating an example system for generating question-answer combinations and/or fine-tuning a language model, where a scenario question answer (SQA) engine generates question-answer combination data, according to some embodiments.

FIG. 1D is a diagram illustrating an example system for generating question-answer combinations and/or fine-tuning a language model, where a validation module validates question-answer combination data, according to some embodiments.

FIG. 1E is a diagram illustrating an example system for generating question-answer combinations and/or fine-tuning a language model, where validated question-answer combination data is used to fine-tune a language model, according to some embodiments.

FIG. 1F is a diagram illustrating an example system for generating question-answer combinations and/or fine-tuning a language model, where a messaging interface is displayed on a client device, according to some embodiments.

FIG. 1G is a diagram illustrating an example system for generating question-answer combinations and/or fine-tuning a language model, where a response to a query is transmitted to a client device, according to some embodiments.

FIG. 1H is a diagram illustrating an example system for generating question-answer combinations and/or fine-tuning a language model, where a response to a query is displayed on a client device, according to some embodiments.

FIG. 1I is a diagram illustrating showing connections and/or interrelationships between components of an example system for generating question-answer combinations and/or fine-tuning a language model, according to some embodiments.

FIG. 2 is a flow chart illustrating an example method, according to some embodiments.

FIG. 3 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for automatically generating question-answer combinations and/or using the document question-answer combinations to fine-tune a language model are provided. A set of content items may be collected from a set of data sources. Intent labels associated and/or sentiments associated with the set of content items may be determined. A first language model may be used to generate a set of question-answer combinations based upon the intent labels and/or the sentiments. A second language model may be fine-tuned based upon the set of question-answer combinations to generate a fine-tuned language model, which may improve an accuracy with which the fine-tuned language model can respond to queries, thereby increasing a likelihood that a user is provided with a desired response using the fine-tuned language model. Accordingly, a likelihood that a live agent is not required to interact with the user to provide the user with the desired response may be reduced. Accordingly, costs and/or manual effort associated with providing the user with the desired response may be reduced.

In some examples, the fine-tuned language model may be used to generate responses to user queries (e.g., from customers seeking customer service) and/or detect customer emotions in real-time to prioritize urgent and/or dissatisfied queries. The fine-tuned language model may be used to analyze logs and/or network traffic for identifying unusual patterns and/or predicting network outages. A network maintenance tool may be used to perform network maintenance on one or more network components based upon the unusual patterns and/or predicted network outages. The fine-tuned language model may be used to generate a plan to fix a network issue based upon one or more error logs and/or tickets, and/or the network maintenance tool may be used to perform network maintenance based upon the plan. The fine-tuned language model may be used to schedule a network upgrade based upon historical data, and/or the network maintenance tool may be used to perform network maintenance based upon the network upgrades. The fine-tuned language model may be used to detect malicious content (e.g., spam, phishing message, virus, etc.), and/or a malicious content filtering tool may be used to block the malicious content from being sent to and/or stored on a client device.

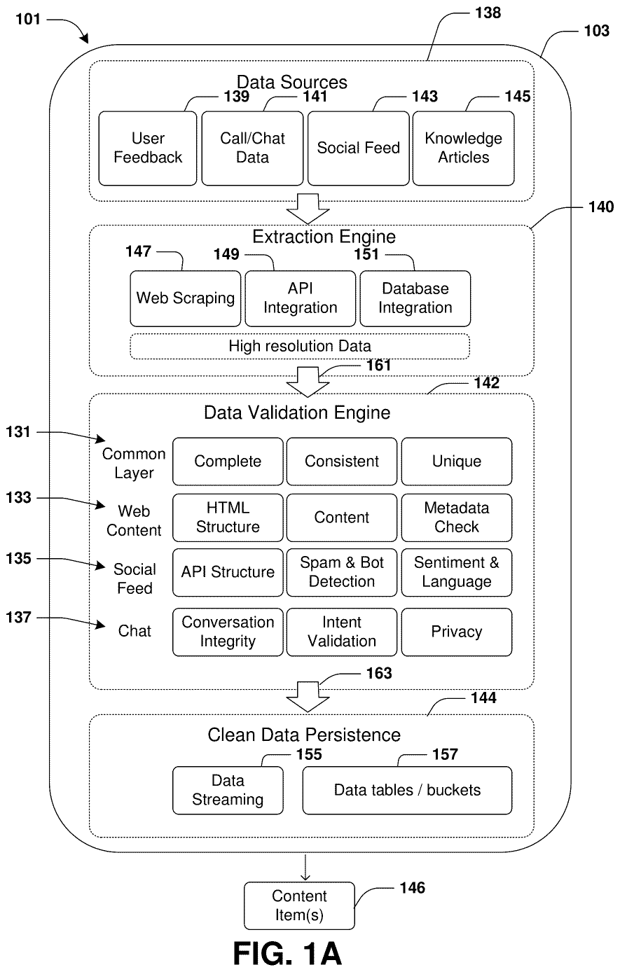

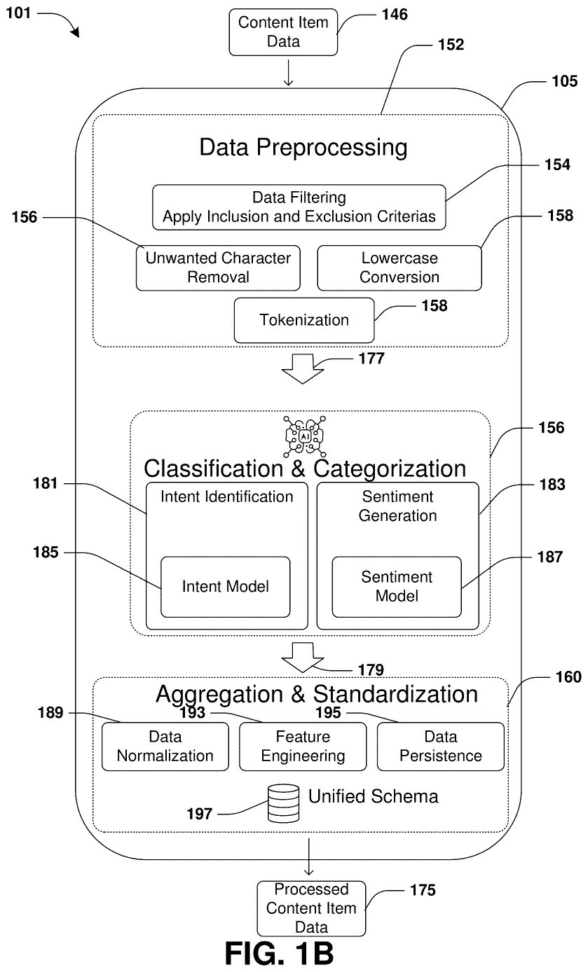

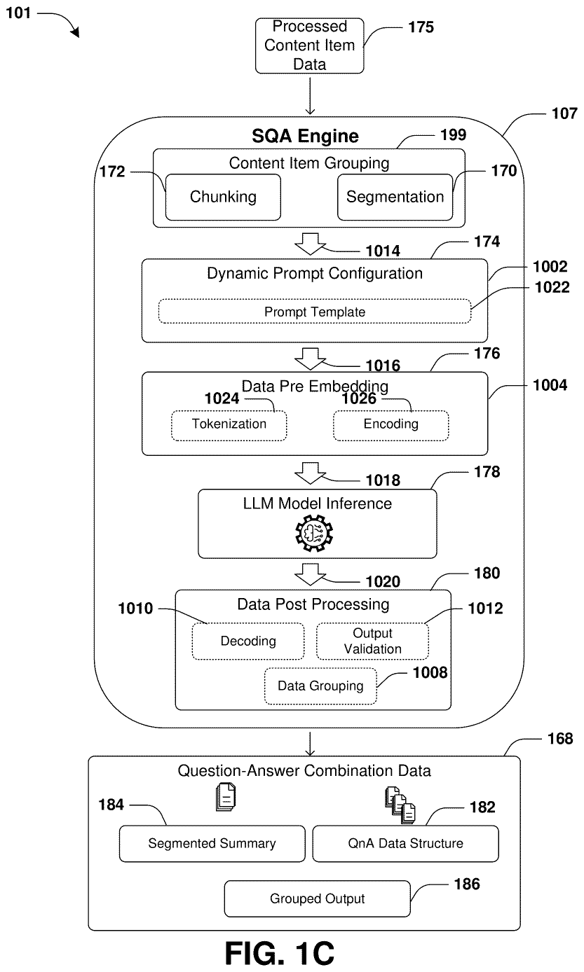

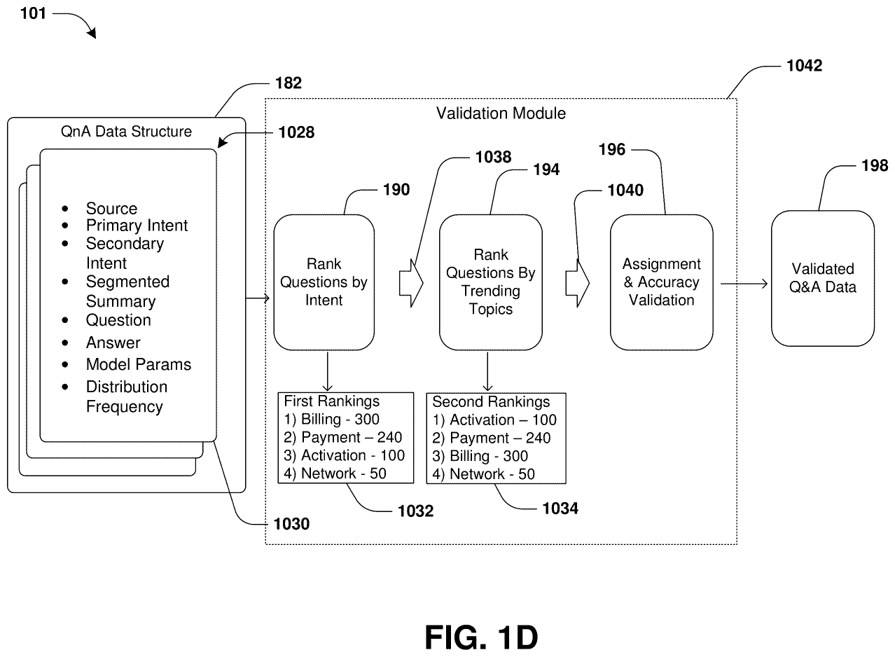

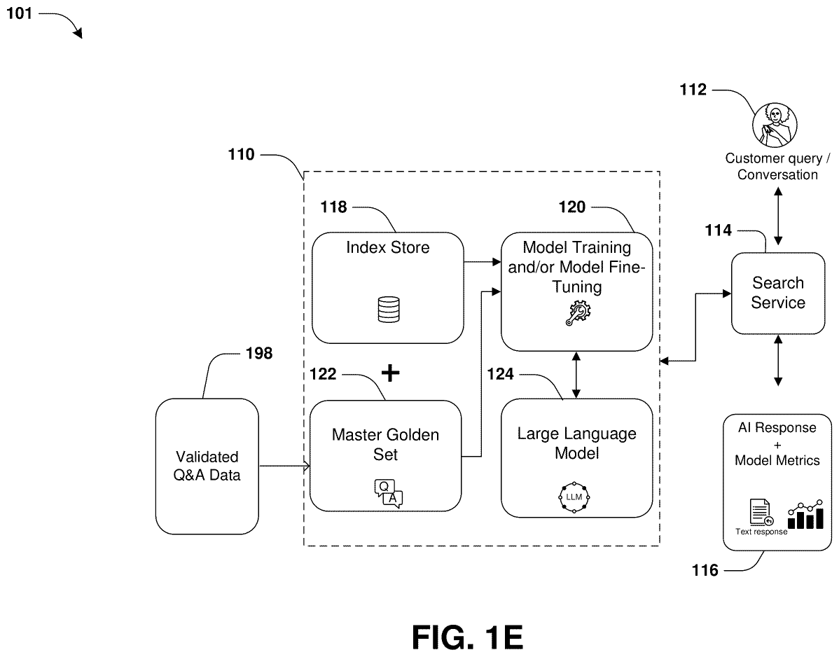

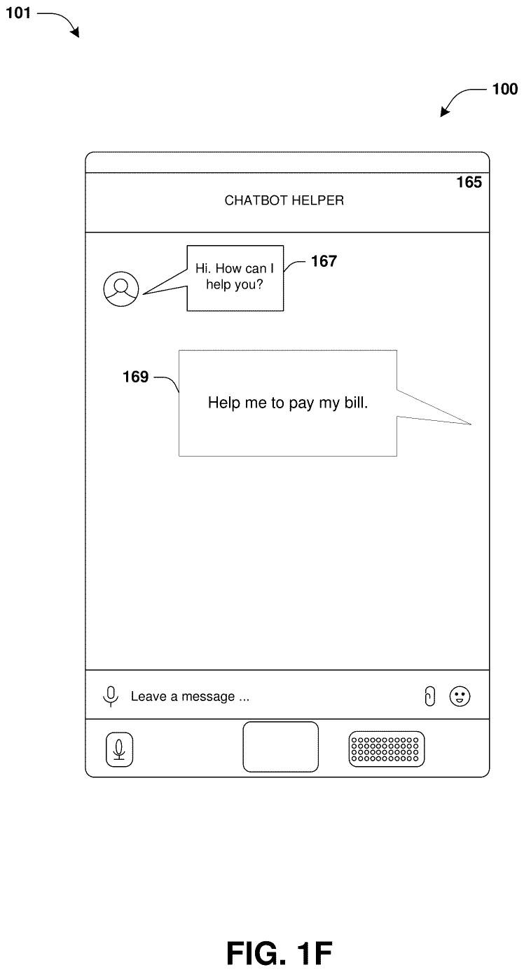

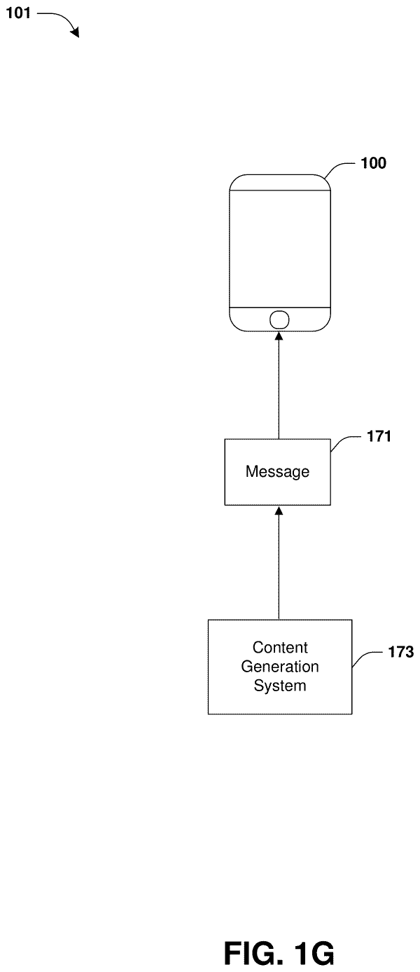

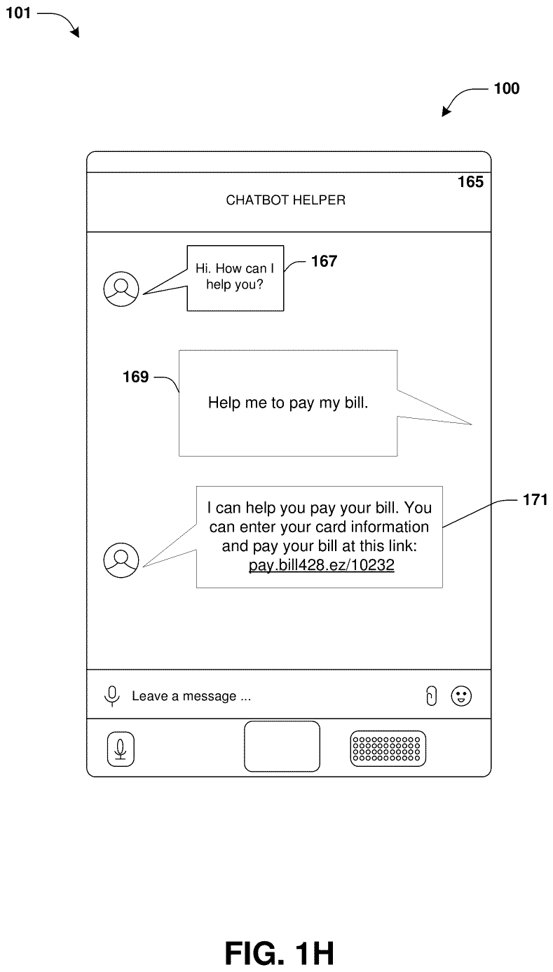

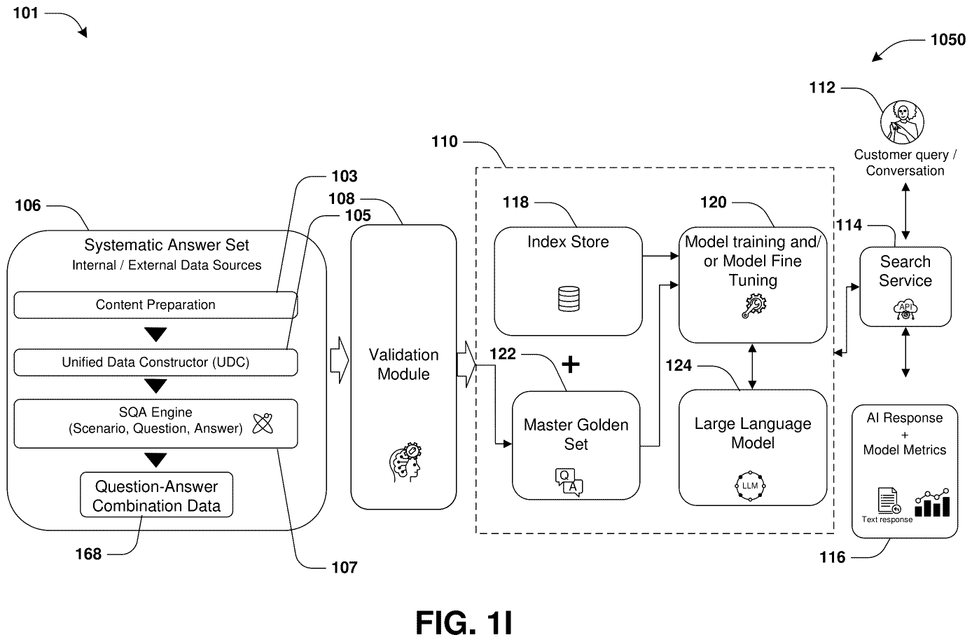

FIGS. 1A-1I illustrate examples of a system 101 for generating question-answer combinations and/or using the document question-answer combinations to fine-tune a language model (via automated self-learning, for example). The language model may be part of a chatbot (also known as chatterbot) system comprising a communication system (e.g., a conversational system). For example, the language model may be used to generate responses to user queries received by the chatbot system. For example, the chatbot system may be used to conduct a conversation (e.g., a chat conversation) with a first user via a messaging interface 165 (shown in FIG. 1F). The chatbot system may be used to provide one or more services to the first user, such as one or more services requested in one or more messages submitted by the first user.

FIG. 1A illustrates a content preparation module 103 (e.g., an automated content preparation module) configured to provide content item data 146 indicative of a set of content items (e.g., a set of one or more content items) for use in generating question-answer combinations. In some examples, the content preparation module 103 may comprise an extraction engine 140 to extract content 161 from a set of data sources 138 (e.g., a set of one or more data sources), a data validation engine 142 for validating the content 161 extracted by the engine 140 to provide validated content 163, and/or a clean data persistence module 144 for cleaning the validated content 163 provided by the data validation engine 142 to provide the content item data 146.

The set of data sources 138 may comprise one or more online sources and/or one or more offline sources. In some examples, the set of data sources 138 may comprise a source of user feedback 139, a source of call and/or chat data 141, a source of social feed data 143, and/or a source of articles 145. The source of user feedback 139 may comprise one or more resources (e.g., web pages, web applications, databases, content hosts, Hypertext Markup Language (HTML) tags and/or pages, etc.) associated with a user feedback platform for receiving user feedback (e.g., customer feedback) associated with an entity (e.g., at least one of a company, a business, etc.) and/or one or more services (e.g., at least one of a telecommunication service, a transportation service, etc.) associated with the entity (e.g., the one or more services may be paid services offered by the entity). The source of call and/or chat data 141 may comprise one or more resources (e.g., web pages, web applications, databases, content hosts, HTML tags and/or pages, etc.) that provides call data indicative of audio of one or more calls (e.g., a customer support call in which a customer speaks with an agent or a robot to address one or more needs associated with the one or more services) and/or chat data indicative of one or more messages of one or more chats (e.g., a chat in which a customer converses with an agent or a chatbot to address one or more needs associated with the one or more services). The source of social feed data 143 may comprise one or more resources (e.g., web pages, web applications, databases, content hosts, HTML tags and/or pages, etc.) associated with a social media platform. The source of articles 145 (e.g., knowledge articles) may comprise one or more resources (e.g., web pages, web applications, databases, content hosts, HTML tags and/or pages, etc.) that provide articles.

The content 161 may comprise structured formats and/or unstructured formats. The content 161 may comprise one or more sets of user feedback (from the source of user feedback 139, for example) comprising at least one of a customer review of a service of the one or more services, a customer survey, a customer rating, a user comment, content indicative of a user's opinion and/or experience associated with the entity and/or the one or more services, a form filled by a user, etc. The content 161 may comprise audio from one or more calls (from the source of call and/or chat data 141, for example), such as one or more customer support calls and/or other types of calls (e.g., customer support calls to serve customers of the entity). In some examples, the content 161 may comprise a transcript of the audio (e.g., the transcript may be generated automatically by performing an audio transcription process on the audio). The content 161 may comprise audio from one or more calls (from the source of call and/or chat data 141, for example) such as one or more customer support calls and/or other types of calls. In some examples, the content 161 may comprise a transcript of the audio (e.g., the transcript may be generated automatically by performing an audio transcription process on the audio).

The content 161 may comprise one or more social feed content items (from the source of social feed data 143, for example) comprising at least one of social media posts, comments (e.g., comments of a social media feed), blogs, etc. The content 161 may comprise one or more social feed interactions (from the source of social feed data 143, for example) comprising likes and/or other reactions to posts and/or comments (e.g., positive reactions such as up-votes and/or negative reactions such as down-votes). In some examples, the one or more social feed content items and/or the one or more social feed interactions may be indicative of at least one of opinions, questions, concerns, sentiments, etc. associated with the entity and/or the one or more services expressed by users (e.g., customers of the one or more services).

The content 161 may comprise one or more articles (from the source of articles 145, for example) comprising at least one of knowledge articles, technical documentation, informational articles, encyclopedic articles, journal articles, Frequently Asked Questions (FAQ) articles, news articles, etc. An article of the one or more articles may comprise text, one or more images and/or one or more videos. An article of the one or more articles may provide information associated with the entity and/or the one or more services, such as guidance (e.g., navigational guidance, explanatory guidance, best practices, etc.) for a task, a question and/or problem associated with the one or more services.

The content 161 (and/or the set of content items indicated by the content item data 146) may comprise a set of field-related content items (e.g., a set of one or more field-related content items) associated with a field. The field may correspond to one or more categories and/or one or more topics associated with the one or more services that are provided by the entity and/or facilitated using the chatbot system. The chatbot system may be used for providing informational content associated with the field and/or may be used for providing customer support for services associated with the field).

A content item of the set of field-related content items may comprise text (e.g., structured sets of text) comprising at least one of definitions of terms associated with the field, usage of terms associated with the field, etc. For example, the content item may comprise at least one of text from one or more articles (e.g., news articles, encyclopedia articles, etc.) related to the field, text from one or more social media posts and/or blogs related to the field, text from documentation (e.g., datasheets, product and/or service specifications, etc.) related to the field, text from one or more webpages related to the field, a glossary and/or dictionary of terms related to the field, etc. In some examples, a processor may be used to read memory on which content associated with the field (e.g., at least one of articles, social media posts, blogs, documentation, webpages, a glossary, a dictionary, etc.) is stored and/or the processor may be used to extract text from the content and/or store the text as a content item of the set of field-related content items in a data store on which the set of field-related content items are stored.

In some examples in which the entity is a telecommunication service provider and/or the field is indicative of telecommunication services, a content item of the set of field-related content items may comprise text comprising at least one of definitions of terms associated with the telecommunication service provider and/or telecommunication services, guidance information indicative of one or more procedures and/or guidelines for configuring and/or installing a product and/or service and/or, troubleshooting information indicative of one or more instructions for troubleshooting a product and/or service, etc. The content item may comprise text from at least one of one or more articles, one or more social media posts, one or more blogs, documentation, one or more webpages, one or more glossaries, one or more dictionaries, etc. related to the telecommunication service provider and/or telecommunication services.

The content 161 (and/or the set of content items indicated by the content item data 146) may comprise a set of general-language context content items (e.g., a set of one or more general-language context content items). In some examples, content of the set of general-language context content items may not be specific to the field. The set of general-language context content items may comprise at least one of articles (e.g., news articles, encyclopedia articles, etc.), social media posts and/or blogs, webpages, a glossary, a dictionary, etc. In some examples, the set of general-language context content items may comprise at least one of an online encyclopedia corpus, a news language corpus, etc. The set of general-language context content items may comprise text comprising usage of a language (e.g., English) in general language context not specific to the field.

The extraction engine 140 may (i) transcribe an audio file to generate text (e.g., a transcription) indicative of speech spoken in the audio file, and/or (ii) generate a content item (e.g., a field-related content item, a general-language context content item, etc.) of the content 161 to comprise the text. Alternatively and/or additionally, the extraction engine 140 may (i) transcribe a video to generate text (e.g., a transcription) indicative of speech spoken in the video, and/or (ii) generate a content item (e.g., a field-related content item, a general-language context content item, etc.) of the content 161 to comprise the text. Alternatively and/or additionally, the extraction engine 140 may (i) analyze a video to generate text describing one or more objects and/or events depicted in the video, and/or (ii) generate a content item (e.g., a field-related content item, a general-language context content item, etc.) of the content 161 to comprise the text. Alternatively and/or additionally, the extraction engine 140 may (i) analyze an image to generate text describing one or more objects and/or events depicted in the image, and/or (ii) generate a content item (e.g., a field-related content item, a general-language context content item, etc.) of the content 161 to comprise the text.

The extraction engine 140 may employ various extraction techniques for data ingestion. The extraction engine 140 may comprise a web scraping module 147 for scraping internet resources for data to include in the content 161. In some examples, the web scraping module 147 may comprise HTML parsing libraries (and/or other types of parsing libraries) configured to extract data from site pages. The extraction engine 140 may comprise an Application Programming Interface (API) integration module 149 configured to perform one or more API-based extraction methods to collect the one or more social feed content items and/or the one or more social feed interactions. In some examples, the API integration module 149 rate limits social feed APIs and/or implements robust error handling with retry mechanisms to manage API errors and/or changes in site structure.

The data validation engine 142 may perform a validation process on the content 161 to generate the validated content 163. In some examples, the data validation engine 142 may comprise schema validation (to check that the content 161 conforms to one or more conditions and/or rules and/or has an expected format and/or data type, for example) and/or assessment of data quality. The data validation engine 142 may comprise one or more first data validation modules 131 to apply to some or all of the content 161, one or more second data validation modules 133 to apply to at least a portion, of the content 161, comprising web content from one or more internet resources, one or more third data validation modules 135 to apply to at least a portion, of the content 161, comprising social feed content (e.g., the one or more social feed content items and/or the one or more social feed interactions), and/or one or more fourth data validation modules 137 to apply to at least a portion, of the content 161, comprising the chat data and/or the call data.

The one or more first data validation modules 131 may comprise a completeness module to check completeness (e.g., identify one or more missing values in one or more fields), a consistency module to check consistency (e.g., validate a format of the one or more fields), a uniqueness module to check for duplicate records, an accuracy module to check accuracy, and/or a timeliness module to check that a timestamp associated with content is within a defined period of time (e.g., a most recent period of 24 hours, 48 hours, 72, hours, 3 weeks, 1 month, or other duration). Some or all of the content 161 may be passed through each of one, some or all of the one or more first data validation modules 131.

The completeness module may validate content in response to determining the content is complete (e.g., the content does not have missing values) and/or may include the content in the validated content 163. In response to a determination that content being checked by the completeness module is not complete (e.g., the content may have one or more missing values), the completeness module may filter out and/or exclude the content from the validated content 163. The consistency module may validate content in response to determining the content is consistent and/or may include the content in the validated content 163. In response to a determination that content being checked by the consistency module is not consistent, the consistency module may filter out and/or exclude the content from the validated content 163.

The uniqueness module may validate content in response to determining the content is unique (e.g., the content is not a duplicate record) and/or may include the content in the validated content 163. In response to a determination that content being checked by the uniqueness module is not unique (e.g., there is a duplicate record of the content in the content 161), the uniqueness module may filter out and/or exclude the content from the validated content 163 (whereas the duplicate record may be included in the validated content 163, for example). The accuracy module may validate content in response to determining the content does not have outliers and/or anomalies and/or may include the content in the validated content 163. In response to a determination that content being checked by the accuracy module has one or more outliers and/or anomalies, the accuracy module may filter out and/or exclude the content from the validated content 163.

The timeliness module may validate content in response to determining the content is associated with a timestamp within the defined period of time and/or may include the content in the validated content 163. In response to a determination that content being checked by the timeliness module is associated with a timestamp that is not within the defined period of time (e.g., the timestamp may correspond to a timestamp that is before the defined period of time, indicating that the content may be out of date and/or not current), the timeliness module may filter out and/or exclude the content from the validated content 163.

The one or more second data validation modules 133 may comprise an HTML structure module, a content validation module and/or a metadata check module. In some examples, web content of the content 161 may be passed through each of one, some or all of the one or more second data validation modules 133. The web content may comprise content, of the content 161, extracted from web-based resources (e.g., web pages, web applications, HTML tags and/or pages, etc.). Embodiments are contemplated in which one or more other types of content of the content 161 (in addition to the web content of the content 161, for example) is passed through each of one, some or all of the one or more second data validation modules 133.

The HTML structure module may validate content in response to determining that the content is not associated with a structure issue (e.g., an HTML structure of the content is correctly formatted) and/or may include the content in the validated content 163. In response to a determination that content being checked by the HTML structure module is associated with a structure issue (e.g., an HTML structure of the content is not correctly formatted), the HTML structure module may filter out and/or exclude the content from the validated content 163. The content validation module may validate content in response to determining that the content is not associated with a content validation issue and/or may include the content in the validated content 163. In response to a determination that content being checked by the content validation module is associated with a content validation issue, the content validation module may filter out and/or exclude the content from the validated content 163. The metadata check module may validate content in response to determining that metadata of the content is not associated with a metadata validation issue and/or may include the content in the validated content 163. In response to a determination that metadata of content being checked by the metadata check module is associated with a metadata validation issue, the metadata check module may filter out and/or exclude the content from the validated content 163.

The one or more third data validation modules 135 may comprise an API structure module, a spam and/or bot detection module and/or a sentiment and/or language module. In some examples, social feed content (e.g., the one or more social feed content items and/or the one or more social feed interactions) of the content 161 may be passed through each of one, some or all of the one or more third data validation modules 135. Embodiments are contemplated in which one or more other types of content of the content 161 (in addition to the social feed content of the content 161, for example) is passed through each of one, some or all of the one or more third data validation modules 135. For example, the chat data and/or the call data of the content 161 may be passed through each of one, some or all of the one or more third data validation modules 135.

The API structure module may validate content in response to determining that the content is not associated with a structure issue (e.g., an API structure of the content is correctly formatted) and/or may include the content in the validated content 163. In response to a determination that content being checked by the API structure module is associated with a structure issue (e.g., an API structure of the content is not correctly formatted), the API structure module may filter out and/or exclude the content from the validated content 163. The spam and/or bot detection module may validate content in response to determining that the content is not associated with spam and/or a malicious bot and/or may include the content in the validated content 163. In response to a determination that content being checked by the spam and/or bot detection module is associated with spam and/or a malicious bot, the spam and/or bot detection module may filter out and/or exclude the content from the validated content 163. The sentiment and/or language module may validate content in response to determining that the content is not associated with a sentiment and/or language issue and/or may include the content in the validated content 163. In response to a determination that content being checked by the sentiment and/or language module is associated with a sentiment and/or language issue (e.g., the content is determined to have an angry sentiment and/or unclear language), the sentiment and/or language check module may filter out and/or exclude the content from the validated content 163.

The one or more fourth data validation modules 137 may comprise a conversation integrity module, an intent validation module and/or a privacy module. The chat data and/or the call data of the content 161 may be passed through each of one, some or all of the one or more fourth data validation modules 137. Embodiments are contemplated in which one or more other types of content of the content 161 (in addition to the chat data and/or the call data of the content 161, for example) is passed through each of one, some or all of the one or more fourth data validation modules 137. For example, the social feed content of the content 161 may be passed through each of one, some or all of the one or more fourth data validation modules 137.

The conversation integrity module may validate content in response to determining that the content is not associated with a conversation integrity issue (e.g., a chat and/or call of the content may have coherent replies, may adhere to expected conversational behavior, etc.) and/or may include the content in the validated content 163. In response to a determination that content being checked by the conversation integrity module is associated with a conversation integrity issue (e.g., a chat and/or call of the content may have incoherent replies, may not adhere to expected conversational behavior, etc.), the conversation integrity module may filter out and/or exclude the content from the validated content 163. The intent validation module may validate content in response to determining that the content is not associated with an intent issue and/or may include the content in the validated content 163. In response to a determination that content being checked by the intent validation module is associated with an intent issue, the intent validation module may filter out and/or exclude the content from the validated content 163. The intent validation module may use a classification model to classify intents associated with content items (e.g., conversation chats) that are associated with successful resolutions of a problem (associated with one or more completed and/or closed topics from a data source, for example), and/or may determine the validated content 163 based upon the intents. For example, the content items associated with successful resolutions of a problem may include a conversation chat (between an agent and a customer, for example) in which a problem and/or issue associated with the customer is successfully resolved. The privacy module may validate content in response to determining that the content is not associated with a privacy issue and/or may include the content in the validated content 163. In response to a determination that content being checked by the privacy module is associated with a privacy issue (e.g., the content is determined to include private user information), the privacy module may filter out and/or exclude the content from the validated content 163 (and/or the privacy module may sanitize the content to generate sanitized content without the private user information and/or may provide the sanitized content for inclusion in the validated content 163).

The clean data persistence module 144 may use a data streaming module 155 and/or a data table and/or bucket management module 157 for cleaning the validated content 163 provided by the data validation engine 142 to generate the content item data 146 indicative of the set of content items. In some examples, the content item data 146 comprises data persisted in data tables (e.g., big data tables) stitched with one or more partition keys and/or stored (by the data streaming module 155 and/or the table and/or bucket management module 157, for example) in buckets that are associated with one or more topics. The data streaming module 155 may comprise a data pipeline for collecting data from one or more sources, transforming the data into normalized data using one or more dataflow tools, storing the normalized data in the buckets (and/or one or more tables, which may be stored in an enterprise data warehouse (EDW) and/or a wide-column store). The collecting of the data, transforming of the data into the normalized data, and/or the storing of the normalized data in the buckets (and/or the one or more tables) may be performed (using a publish/subscribe (Pub/Sub) service and/or other service, for example) in real time (as part of a real-time data streaming service, for example). In some examples, each of the buckets may be associated with one or more topics which classify a category associated with the bucket. For example, content determined to be associated with one or more first topics may be included in a first bucket of the buckets and/or content determined to be associated with one or more second topics may be included in a second bucket of the buckets.

FIG. 1B illustrates a content processing module 105 (e.g., a unified data constructor (UDC)) configured to process the content item data 146 to generate processed content item data 175 indicative of the set of content items and/or classification and/or categorization information associated with the set of content items. The content item data 146 may comprise structured data and/or unstructured data. The content item data 146 is consolidated into a single processing pipeline of the content processing module 105 that is tailored to handle requirements associated with structured data and requirements associated with unstructured data separately (and/or together). In some examples, the processing pipeline (and/or the content preparation module 103) may comprise a data preprocessing module 152 to perform a preprocessing stage on the content item data 146 to generate preprocessed content item data 177, a classification and/or categorization module 154 for classifying and/or categorizing content to determine intent labels and/or sentiments associated with content items of the set of content items and/or generate data 179 indicative of the intent labels and/or the sentiments, and/or a data aggregation and/or standardization module 160 for generating the processed content item data 175 based upon the data 179.

The data preprocessing module 152 may comprise a data filtering module 154 to filter unwanted data such that the preprocessed content item data 177 does not comprise the unwanted data, an unwanted character removal module 156 to remove one or more unwanted characters from the content item data 146 such that the preprocessed content item data 177 does not comprise the one or more unwanted characters, a lowercase conversion module 158 to convert uppercase characters to lowercase characters (e.g., “And” in the content item data 146 may be changed to “and” in the preprocessed content item data 177) and/or a first tokenization module 158 configured to divide text of the content item data 146 into units comprising at least one of words, phrases, symbols, etc. to be included in the preprocessed content item data 177, thereby making the preprocessed content item data 177 more manageable and/or interpretable for analysis and/or language model self-learning.

The classification and/or categorization module 154 may comprise an intent identification module 181 and/or a sentiment generation module 183. In some examples, the intent identification module 181 uses an intent model 185 (e.g., intent classification model) to determine intent labels associated with the set of content items. For example, the intent identification module 181 may use the intent model 185 to analyze data (of the preprocessed content item data 177, for example) associated with a first content item of the set of content items to determine a first set of intent labels (e.g., a first set of one or more intent labels) associated with the first content item. The intent identification module 181 may use the intent model 185 to analyze data (of the preprocessed content item data 177, for example) associated with a second content item of the set of content items to determine a second set of intent labels (e.g., a second set of one or more intent labels) associated with the second content item.

The first set of intent labels may comprise a first intent label indicative of a first primary intent (e.g., parent intent) associated with the first content item and/or a second intent label indicative of a first secondary intent (e.g., child intent) associated with the first content item. In some examples, the first primary intent may correspond to a main goal, purpose and/or interest associated with the first content item and/or the first secondary intent may correspond to a supplementary and/or supporting goal, purpose and/or interest associated with the first content item (e.g., the first secondary intent may provide further context to the first primary intent). The first content item may comprise a customer support chat in which a customer converses with an agent or a chatbot to perform a service activation for a phone. For example, the first content item may comprise one or more messages guiding the customer through one or more stages to complete the service activation. The first primary intent associated with the first content item may be indicative of phone service activation, and/or the first secondary intent may be indicative of phone service activation for a phone model corresponding to the phone (e.g., a version, product line and/or type of phone).

The second set of intent labels may comprise a third intent label indicative of a second primary intent associated with the second content item and/or a fourth intent label indicative of a second secondary intent associated with the second content item. The second primary intent may correspond to a main goal, purpose and/or interest associated with the second content item and/or the second secondary intent may correspond to a supplementary and/or supporting goal, purpose and/or interest associated with the second content item. The second content item may comprise a social media thread comprising a social media post by a customer and/or one or more comments to the social media post. For example, the social media post may be indicative of intermittent internet outages of the customer's internet service and/or ask for guidance to improve the internet service. The one or more comments may comprise one or more messages indicative of potential solutions to improve the internet service. The second primary intent associated with the second content item may be indicative of internet service maintenance, and/or the second secondary intent may be indicative of mitigating internet outages.

The sentiment generation module 183 uses a sentiment model 187 (e.g., intent classification model) to determine sentiments associated with the set of content items. For example, the sentiment generation module 183 may use the sentiment model 187 to analyze data (of the preprocessed content item data 177, for example) associated with the first content item to determine a first sentiment associated with the first content item. For example, the sentiment generation module 183 may use the sentiment model 187 to evaluate a tone of the first content item to determine the first sentiment, which may be positive, negative, neutral, or other value. In some examples, the first sentiment may be indicative of an emotional tone, attitude, feelings, etc. expressed within the first content item (which may reflect how a customer feels about a service they are provided with, for example). The sentiment generation module 183 may use the sentiment model 187 to analyze data (of the preprocessed content item data 177, for example) associated with the second content item to determine a second sentiment associated with the second content item.

The intent model 185 may comprise a first transformer model comprising at least one of a first self-attention mechanism, a first positional encoding mechanism, a first encoder-decoder structure, a first multi-head attention structure, one or more first feedforward networks (e.g., one or more feedforward neural networks), etc. The sentiment model 187 may comprise a second transformer model comprising at least one of a second self-attention mechanism, a second positional encoding mechanism, a second encoder-decoder structure, a second multi-head attention structure, one or more second feedforward networks (e.g., one or more feedforward neural networks), etc.

The classification and/or categorization module 154 may provide the data 179 (which may be indicative of the set of content items, the intent labels and/or the sentiments, for example) to the data aggregation and/or standardization module 160 which may perform data aggregation and/or data standardization on the data 179 to generate the processed content item data 175. In some examples, the data aggregation comprises compiling information from various stages of filtered data into a (unified) query-able and/or tabular view, which may be beneficial for gaining a comprehensive understanding of the subject matter. The data standardization process may comprise standardizing the data 179 (in a templatized format, for example). In some examples, the processed content item data 175 may be stored in data tables, which may provide for efficient retrieval to feed as input to other models and/or data analytics. In some examples, the classification and/or categorization module 154 may comprise a data normalization module 189 to perform the data standardization process, a feature engineering module 193 and/or a data persistence module 195. In some examples, the processed content item data 175 is generated to have a unified schema 197 such that at least one of a structure, format, etc. of datasets of the processed content item data 175 are standardized and/or consistent.

FIG. 1C illustrates a scenario question answer (SQA) engine 107 (e.g., an automated question-answer combination generation engine) configured to use the processed content item data 175 (e.g., standardized data input) to generate question-answer combination data 168 indicative of question-answer combinations. The SQA engine 107 may comprise a content item grouping module 199 to group content items of the set of content items into a plurality of groups, a dynamic prompt configuration module 174 to generate one or more prompts, a data pre-embedding module 176 to tokenize and/or encode data, a model inference module 178 to generate question-answer combinations, and/or a data post processing module 180 configured to generate the question-answer combination data 168.

The content item grouping module 199 may comprise a chunking module 172 to break down (relatively large) data sets in the processed content item data 175 into processed data comprising smaller (and/or more manageable) data sets. In some examples, the processed data may be provided to the segmentation module 170, which may use the processed data to group content items of the set of content items into the plurality of groups and/or divide the processed data into a plurality of sections (e.g., meaningful and/or organized sections associated with coherent units of data that aligns with and/or understands a structure of a content item for further processing). The plurality of sections may be associated with the plurality of groups. For example, the plurality of sections may comprise a first section comprising data associated with a first group of content items of the plurality of groups, a second section comprising data associated with a second group of content items of the plurality of groups, etc. In some examples, using the chunking module 172 to break down larger data sets into smaller data sets may enable the segmentation module 170 (and/or one or more other components of the SQA engine 107) to process larger amounts of information more efficiently (such that more information can be handled within the constraints of memory and computational power, for example).

The segmentation module 170 may group the set of content items into the plurality of groups based upon the intent labels and/or the sentiments. For example, the segmentation module 170 may include content items in the first group of content items based upon a determination that the content items share matching (e.g., the same and/or similar) primary intents, the content items share matching (e.g., the same and/or similar) secondary intents and/or the content items share matching (e.g., the same and/or similar) sentiments. One or more first groups of the plurality of groups may include content items (e.g., the first content item) that are associated with intents (e.g., primary intents and/or secondary intents indicated by intent labels) associated with phone service activation (and/or one or more other intents). One or more second groups of the plurality of groups may include content items (e.g., the first content item) that are associated with intents (e.g., primary intents and/or secondary intents indicated by intent labels) associated with internet service maintenance (and/or one or more other intents).

Content items associated with phone service activation may be divided amongst groups of the one or more first groups based upon sentiment. In some examples, the one or more first groups comprise the first group of content items that are associated with phone service activation and/or negative sentiments, the second group of content items that are associated with phone service activation and/or neutral sentiments, and/or a third group of content items that are associated with phone service activation and/or positive sentiments.

Content items associated with internet service maintenance may be divided amongst groups of the one or more second groups based upon sentiment. In some examples, the one or more second groups comprise a fourth group of content items that are associated with internet service maintenance and/or negative sentiments, a fifth group of content items that are associated with internet service maintenance and/or neutral sentiments, and/or a sixth group of content items that are associated with internet service maintenance and/or positive sentiments.

The dynamic prompt configuration module 174 may be configured to generate one or more prompts for submission to the model inference module 178. In some examples, the dynamic prompt configuration module 174 may generate the one or more prompts based upon the intent labels associated with the set of content items, the sentiments associated with the set of content items, the plurality of groups, and/or the set of content items. For example, the dynamic prompt configuration module 174 may generate the one or more prompts based upon data 1014 (from the content item grouping module 199, for example) indicative of the intent labels, the sentiments, the plurality of groups, and/or the set of content items. The data 1014 may comprise data (e.g., broken-down data in relatively smaller datasets) output by the chunking module 172 and/or the segmentation module 170.

The one or more prompts may comprise a first prompt. The first prompt may comprise one or more instructions based upon which the model inference module 178 may generate one or more question-answer combinations for inclusion in the question-answer combination data 168. In some examples, the first prompt may comprise an instruction to produce one or more question-answer combinations based upon data (e.g., at least some of the data 1014) associated with one or more content items of the set of content items. In some examples, the first prompt may comprise output information indicative of one or more characteristics (e.g., formatting, a type of information to include, etc.) of an output to be generated by the model inference module 178. For example, the output information may instruct the model inference module 178 to produce an output comprising a question-answer combination comprising a question and an answer to the question, context information indicative of a context of a scenario associated with the question-answer combination, action information indicative of one or more actions performed in the scenario, and/or example information indicative of example details associated with the scenario.

The dynamic prompt configuration module 174 may generate the first prompt using one or more prompt templates 1022 (e.g., one or more predefined prompt templates stored in memory). For example, the dynamic prompt configuration module 174 may apply contextually relevant information (e.g., information extracted from the data 1014) to a prompt template of the one or more prompt templates 1022 to generate the first prompt. It may be appreciated that using the dynamic prompt configuration module 174 to dynamically generate the first prompt may result in improved question-answer combination generation with increased accuracy and/or relevancy, which may provide for improved generation of contextually relevant inputs (by a language model that is fine-tuned using question-answer combinations generated using the model inference module 178, for example) tailored to a task and/or question being addressed.

The data pre-embedding module 176 may comprise a second tokenization module 1024 and/or an encoding module 1026. In some examples, the second tokenization module 1024 is configured to divide text of data 1016 (e.g., the data 1016 may comprise the one or more prompts generated using the dynamic prompt configuration module 174 and/or other information indicative of at least one of the intent labels, the sentiments, the plurality of groups, and/or the set of content items) into text data divided along (smaller) units comprising at least one of words, phrases, symbols, etc. The encoding module 1026 may transform the text data (divided along the smaller units, for example) into encoded data 1018 comprising vectors (e.g., the vectors may comprise numerical representations of the text data). The encoded data 1018 may be indicative of the one or more prompts generated using the dynamic prompt configuration module 174 and/or other information indicative of at least one of the intent labels, the sentiments, the plurality of groups, and/or the set of content items.

The encoded data 1018 may be provided to the model inference module 178, which may generate an output 1020 based upon the encoded data 1018. For example, the model inference module 178 may use a first language model to generate the output 1020 indicative of question-answer combinations. In some examples, the first language model may generate the output 1020 by performing operations (e.g., inference operations) in accordance with operations indicated by the one or more prompts.

The output 1020 may be provided to the data post processing module 180, which may process the output 1020 to generate the question-answer combination data 168. For example, the post processing module 1020 may comprise a decoding module 1010 to decode the output 1020 to generate a decoded output (e.g., decoding the output 1020 may comprise converting machine readable data of the output 1020 into text to be included in the decoded output, wherein the text may have a templatized prompt). The post processing module 1020 may comprise an output validation module 1012 and/or a data grouping module 1008 to make one or more adjustments to the decoded output to generate the question-answer combination data 168 to have one or more desired formats.

The question-answer combination data 168 may comprise a question-answer combination data structure 182 indicative of the question-answer combinations, a summary 184 (e.g., segmented summary) comprising a summarized version of the question-answer combinations and/or a grouped output 186 indicative of groups of question-answer combinations. In some examples, the question-answer combinations indicated by the output 1020 may be grouped into the groups indicated by the grouped output 186 based upon intents (e.g., primary and/or secondary intents) associated with the question-answer combinations and/or sentiments associated with the question-answer combinations.

FIG. 1D illustrates performance of a validation process using a validation module 1042 to generate a validated question-answer data 198 based upon the question-answer combination data structure 182 of the question-answer combination data 168. In some examples, the question-answer combination data structure 182 may comprise a plurality of question-answer combination profiles 1028 associated with the question-answer combinations indicated by the output 1020. For example, each question-answer combination profile of one, some and/or all of the plurality of question-answer combination profiles 1028 may comprise a question of a question-answer combination, an answer to the question, context information indicative of a context of a scenario associated with the question-answer combination, action information indicative of one or more actions performed in the scenario, and/or example information indicative of example details associated with the scenario.

The plurality of question-answer combination profiles 1028 may comprise a first question-answer combination profile 1030 indicative of a first question-answer combination. The first question-answer combination profile 1030 may be indicative of a source associated with the first question-answer combination (e.g., the source may correspond to a content item based upon which the first question-answer combination is generated, such as a knowledge article, a set of text, etc. from the set of content items), a primary intent associated with the first question-answer combination, a secondary intent associated with the first question-answer combination, a summary (e.g., segmented summary) of the first question-answer combination, a question of the first question-answer combination, an answer to the question, one or more model parameters used to generate the first question-answer combination, and/or a distribution frequency associated with the first question-answer combination. The primary intent may be indicative of a (main) goal, purpose and/or interest associated with the question (e.g., an intent of a person who would pose the question) and/or the secondary intent may be indicative of a (supplementary) goal, purpose and/or interest associated with the question. In some examples, the distribution frequency may correspond to a frequency (and/or quantity) with which queries related to the first question-answer combination are received by a content generation system 173 (shown in FIG. 1G). For example, the queries may be associated with intents that match the primary intent (and/or the secondary intent) associated with the first question-answer combination.

The first question-answer combination may include a first question, such as “How can I activate my new Deluxe 7 smartphone?”, and a first answer to the first question, such as “Activate your Deluxe 7 smartphone by clicking on the activate button in your subscriber profile”. The first question-answer combination profile 1030 may be indicative of context information indicative of a context of a scenario associated with the first question-answer combination (e.g., a customer needs assistance activating a phone), action information indicative of one or more actions performed in the scenario (e.g., activating a phone by selecting an activate button), and/or example information indicative of example details associated with the scenario (e.g., a type of phone Deluxe 7). The first question-answer combination profile 1030 may be indicative of one or more intents (e.g., “phone activation” as primary intent and/or “Deluxe 7” as secondary intent).

The validation module 1042 may comprise a first ranking module 190, a second ranking module 194 and/or an assignment and/or accuracy validation module 196. The first ranking module 190 may rank question-answer combinations by intent (e.g., primary intent) and/or distribution frequencies associated with the question-answer combinations. The first ranking module 190 may generate a first ranked list 1032 that indicates that “Billing” question-answer combinations (e.g., question-answer combinations associated with intents, such as primary intents, corresponding to billing issues) are highest ranked, “Payment” question-answer combinations (e.g., question-answer combinations associated with intents, such as primary intents, corresponding to payment issues) are ranked below the “Billing” question-answer combinations, “Activation” question-answer combinations (e.g., question-answer combinations associated with intents, such as primary intents, corresponding to activation issues) are ranked below the “Payment” question-answer combinations, and/or “Network” question-answer combinations (e.g., question-answer combinations associated with intents, such as primary intents, corresponding to network issues) are ranked below the “Activation” question-answer combinations. The first ranked list 1032 may indicate the “Billing” question-answer combinations are ranked higher than the “Payment” question-answer combinations based upon a determination that a first distribution frequency (e.g., 300) of question-answer combinations associated with billing issue intents is greater than a second distribution frequency (e.g., 240) of question-answer combinations associated with payment issue intents. The first ranking module 190 may provide data 1038 indicative of the first ranked list 1032 to the second ranking module 194.

The second ranking module 194 may rank question-answer combinations by topic trend scores associated with the question-answer combinations and/or metrics associated with trends of non performing (e.g., poorly performing) intents. The second ranking module 194 may comprise a metric fetching module to retrieve the metrics associated with trends of non performing (e.g., poorly performing) intents, and/or the second ranking module 194 may rank the question-answer combinations based upon the metrics to generate a second ranked list 1032. In some examples, the second ranking module 194 may make one or more adjustments to the first ranked list 1032 to generate the second ranked list 1034 (e.g., the second ranked list 1034 may be a re-ranked version of the first ranked list 1032). The second ranking module 194 may provide data 1040 indicative of the second ranked list 1034 to the assignment and/or accuracy validation module 196.

The assignment and/or accuracy validation module 196 may match ranked topics and/or intents indicated by the second ranked list 1034 with historical topic trends, such as by comparing current topics with past data to identify patterns and ensure consistency. Matching topics with historical trends may help in validating whether outputs of the content generation system 173 are contextually relevant over time. The assignment and/or accuracy validation module 196 may determine one or more validation scores (e.g., at least one of a Bilingual Evaluation Understudy (BLEU) score, a Recall-Oriented Understudy for Gisting Evaluation (ROUGE) score, a Semantic Similarity score, Receiver Operating Characteristic - Area Under Curve (ROC AUC) score, F1 score, etc.) by comparing generated answers in the question-answer combinations indicated by the plurality of question-answer combination profiles 1028 with reference answers.

The assignment and/or accuracy validation module 196 may include a question-answer combination profile (of the plurality of question-answer combination profiles 1028) in the validated question-answer data 198 based upon a determination that a validation score (e.g., BLEU score, ROUGE score, etc.) associated with the question-answer combination is greater than a threshold. The assignment and/or accuracy validation module 196 may exclude a question-answer combination profile (of the plurality of question-answer combination profiles 1028) from the validated question-answer data 198 based upon a determination that a validation score (e.g., BLEU score, ROUGE score, etc.) associated with the question-answer combination is less than a threshold. The assignment and/or accuracy validation module 196 may update the second ranked list 1034 to generate a third ranked list based upon the one or more validation scores, and/or may include information indicative of the third ranked list in the validated question-answer data 198. In some examples, the assignment and/or accuracy validation module 196 may select a highest ranked subset of question-answer combinations for inclusion in the validated question-answer data 198, and/or may exclude one or more lowest ranked question-answer combinations from the validated question-answer data 198.

The validated question-answer data 198 may comprise question-answer combination profiles indicative of question-answer combinations and/or other information (e.g., at least one of source, primary intent, etc.) associated with the question-answer combinations, and/or rankings associated with the question-answer combinations (e.g., the third ranked list), links to sources associated with the question-answer combinations (e.g., the links may be used to access knowledge articles based upon which the question-answer combinations are generated).

In some examples, the validated question-answer data 198 may undergo a supervised validation and/or correction process in which one or more agents (e.g., humans) review at least some of the validated question-answer data 198 and/or make one or more adjustments to the validated question-answer data 198 to improve an accuracy and/or quality of the validated question-answer data 198 and/or to enrich the validated question-answer data 198.

FIG. 1E illustrates use of the validated question-answer data 198 to fine-tune a second language model 124 of a model self-learning system 110. The model self-learning system 110 may comprise a master golden set data store 122, an index store 118 (e.g., with structured and/or unstructured content), a model training and/or fine-tuning module 120, and/or the second language model 124. Original content items (e.g., an original version of the set of content items) used to generate question-answer combinations may be stored in the index store 118. The validated question-answer data 198 may be stored in the master golden set data store 122. The validated question-answer data 198 (and/or other data in the master golden set data store 122) may be used by the model training and/or fine-tuning module 120 to fine-tune (e.g., make one or more adjustments to) the second language model 124 to generate a fine-tuned version of the second language model 124 (e.g., a fine-tuned language model). The fine-tuned version of the second language model 124 may be used for responding to queries with improved accuracy (to provide for improved customer service, for example).

For example, the second language model 124 may comprise a base language model that is trained with training content (e.g., knowledge articles, documentation, one or more field-related content items such as the set of field-related content items and/or other field-related content items, internal content of an entity such as the telecommunication service provider, etc.). The second language model 124 (e.g., the base model) may be fine-tuned using the validated question-answer data 198 to generate the fine-tuned version of the second language model 124. For example, the model training and/or fine-tuning module 120 may use the validated question-answer data 198 as an instructional prompt and/or may execute the instructional prompt by performing one or more task and/or sequential-based fine tune tactics to learn additional knowledge and/or context. The model training and/or fine-tuning module 120 may use the learned additional knowledge and/or context to update one or more weights and/or one or more biases of the second language model 124 (e.g., the base model) to generate the fine-tuned version of the second language model 124, which may improve one or more skills (e.g., summarization skills, question-answering skills and/or other content generation skills) of the fine-tuned version of the second language model 124. In an example, a loss associated with the second language model 124 (e.g., the base model) may be determined based upon a loss function. The one or more weights and/or the one or more biases may be modified to reduce and/or minimize the loss.

A search service 114 may receive queries (e.g., search queries received via a search interface) from one or more users 112, may generate responses to the queries using the second language model 124 (e.g., the fine-tuned version of the second language model 124), and/or may provide the responses to the one or more users 112. An artificial intelligence (AI) response monitoring tool 116 may collect feedback (e.g., responses generated using the second language model 124, model metrics, etc.) and/or use the feedback to fine-tune the second language model 124.

The content generation system 173 (shown in FIG. 1G) may use the second language model 124 (e.g., the fine-tuned version of the second language model 124) to generate a first response to a first query. In some examples, the first query may be received via the messaging interface 165 displayed on a first client device 100 (e.g., a phone, a laptop, a computer, a wearable device, a smart device, a television, user equipment (UE), any other type of computing device, hardware, etc.) associated with the first user.

FIG. 1F illustrates the messaging interface 165 displayed via the first client device 100 associated with the first user. The messaging interface 165 (e.g., a chatbot messaging interface) may be used for receiving one or more messages input via the first client device 100. A message may be input by the first user by typing the message into the messaging interface 165 using a keyboard (e.g., at least one of a physical keyboard, a touchscreen, etc.). Alternatively and/or additionally, a voice recognition system may be used to convert audible speech recorded by the first client device 100 into text.

In FIG. 1F, a first message 167 generated by the chatbot system (e.g., generated by the communication system) may be transmitted to the first client device 100 and/or displayed via the messaging interface 165 (e.g., the first message 167 may be displayed as a starting message of a conversation between the first user and the chatbot system). A second message 169, indicative of the first query, may be received from the first client device 100 via the messaging interface 165. The first query may correspond to a request for a service, such as a request to generate content (e.g., formatted text and/or other content), a request for an action to be performed, etc. In the example shown in FIG. 1F, the first query comprises “Help me to pay my bill.” and corresponds to a request for assistance in paying a bill. The bill may correspond to a phone bill of the first user with a telecommunication service provider, wherein the chatbot system is configured to provide users with services related to the telecommunication service provider, such as providing information associated with different service plans to assist a user in choosing a service plan, subscribing a user to a chosen service plan, activating and/or deactivating one or more features of a service plan, paying a bill associated with a service plan, etc. In some examples, the chatbot system may be configured to provide users with other types of services, such as services related to at least one of an airline (e.g., the chatbot system may be used to at least one of book and/or cancel flights with the airline, choose seats on a flight, provide information associated with a flight, etc.), a shopping website (e.g., the chatbot system may be used to at least one of facilitate a purchase of a product, provide inventory information associated with a product, provide shipping information, etc.), etc.

The content generation system 173 may perform one or more first operations based upon the first query. The one or more first operations may comprise generating the first response to the first query. The one or more first operations may comprise performing one or more actions, such as purchase a product requested by the first query, reserve a seat on a flight based upon the first query, reserve one or more accommodations for a reserved ticket, etc. In some examples in which the first query is a request for assistance in paying the bill, the content generation system 173 may generate a link to a payment web page for paying the bill, may include the link in the first response and/or may automatically pay the bill (e.g., the first response may comprise a confirmation message indicating that the bill has been paid and/or indicating an amount paid. FIG. 1G illustrates a third message 171 comprising the first response being transmitted by the content generation system 173 to the first client device 100. FIG. 1H illustrates the third message 171 displayed via the messaging interface 165. FIG. 1I illustrates a system representation 1050 showing connections and/or interrelationships between aforementioned components of the system 101.

In some examples, at least some of the present disclosure may be performed and/or implemented automatically and/or in real time. For example, at least some of the present disclosure may be performed and/or implemented such that communication between the first user and the chatbot system is performed quickly (e.g., instantly) and/or in real time. In some examples, at least some operations provided herein (e.g., at least one of generating the first response, etc.) may be performed automatically and/or in real time in response to (e.g., upon) reception of the first query via the messaging interface 165. In some examples, at least some of the operations may be performed using the first client device 100 (e.g., a processor of the first client device 100 may perform at least some of the operations using a program installed on the first client device 100). Alternatively and/or additionally, at least some of the operations may be performed using a computer (e.g., a server hosting an application providing generative AI services) that may be connected to the first client device 100 via one or more networks (and/or the Internet).

In some examples, the first language model and/or the second language model 124 may be the same language model or may be different language models. For example, the first language model may be the same as or different than the second language model 124.

Implementation of at least some of the disclosed subject matter may lead to benefits including, but not limited to, reduced (and/or zero) manual effort in comparison with some manual model training and/or fine-tuning techniques that rely on one or more people to manually train and/or fine-tune language models. In accordance with some of the techniques provided herein, the system 101 may perform an automated language model fine-tuning process comprising automatically collecting content (e.g., current and/or recently published content) from the set of data sources 138, automatically generating validated question-answer data (e.g., the validated question-answer data 198) based upon the collected content and/or automatically fine-tuning the second language model 124 using the validated question-answer data. The system 101 may perform automated language model fine-tuning processes (periodically such as biweekly or at another rate or in an aperiodic manner, for example) to improve the second language model 124 over time.

Implementation of at least some of the disclosed subject matter may lead to benefits including, but not limited to, more accurate and/or appropriate response to a message received from a client device, wherein the response has a higher probability of being desired and/or intended by a user of the client device. By leveraging real customer conversations (e.g., extracted from customer support calls and/or chats), question-answer combinations generated using the present disclosure are more likely to address actual customer queries accurately and/or contextually by using machine learning techniques (with supervised human intervention to refine the domain specific question-answer combinations, for example) such that a language model fine-tuned using the question-answer combinations may generate responses to customers more accurately and/or with increased relevance to received queries.

Alternatively and/or additionally, implementation of at least some of the disclosed subject matter may lead to benefits including a reduction in screen space and/or an improved usability of a display (e.g., of the client device) (e.g., as a result of the higher probability of the response being desired by the user, wherein the user may not need to open a separate application and/or a separate window to find the desired response).

Alternatively and/or additionally, the disclosed subject matter may lead to improved agility of the content generation system 173 (e.g., improved responsiveness to market changes), such as due, at least in part, to fine-tuning the second language model 124 (via performing proactive regular updates and/or optimizations to the second language model 124 and/or its knowledge base, for example), where the second language model 124 may adapt quickly to evolving customer behavior and/or market trends, for example. Alternatively and/or additionally, the disclosed subject matter may enable continuous improvements and/or may reduce the time required to deploy updates, ensuring that an organization can benefit from enhancements without delay. A modular architecture of the system 101 (that may separate model fine-tuning and knowledge base maintenance into distinct components, for example) may provide for easy reusability in different similar products within an organization. Framework driven automated validation with AI models can be leveraged for new conversational AI initiatives, reducing development time and/or improving performance. Alternatively and/or additionally, the disclosed subject matter may enhance customer understanding by way of enabling models to capture and reflect specific customer needs, providing tailored and relevant responses, increasing self-service efficiency and/or providing for an easily accessible and/or quickly retrievable knowledge base.

In some examples, each language model of one, some and/or all of the language models herein (e.g., the first language model and/or the second language model 124) may comprise a large language model and/or a generative artificial intelligence (AI) tool. Alternatively and/or additionally, each language model of one, some and/or all of the language models herein (e.g., the first language model and/or the second language model 124) may comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

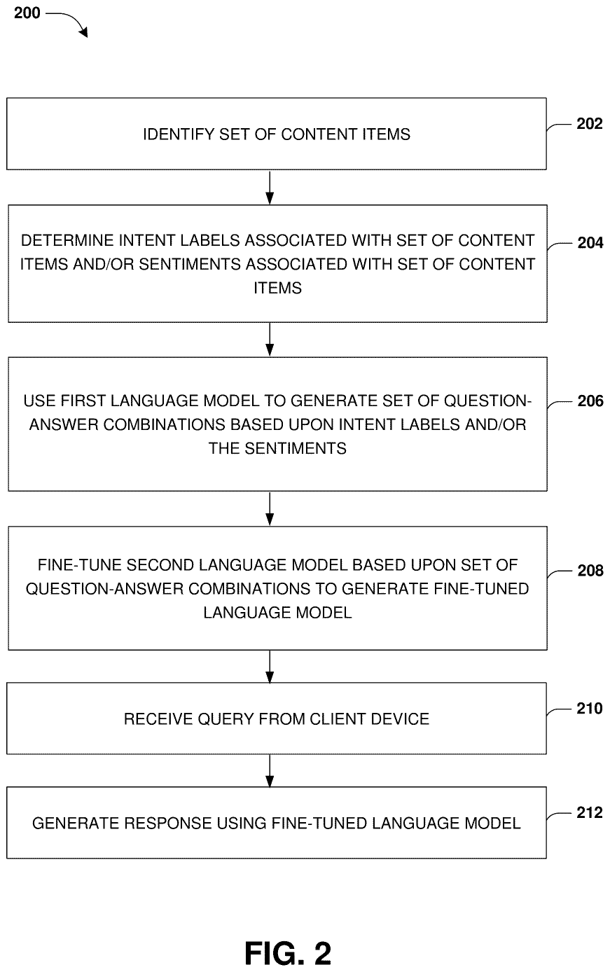

An embodiment of generating question-answer combinations and/or using the document question-answer combinations to fine-tune a language model is illustrated by an exemplary method 200 of FIG. 2. At 202, a set of content items may be identified. At 204, intent labels associated with the set of content items and/or sentiments associated with the set of content items may be determined. At 206, a first language model (e.g., the first language model of the model inference module 178) may be used to generate a set of question-answer combinations based upon the intent labels and/or the sentiments. For example, the set of question-answer combinations may be indicated by the validated question-answer data 198. A first question-answer combination of the set of question-answer combinations may include a first question and a first answer to the first question. At 208, a second language model (e.g., the second language model 124) may be fine-tuned based upon the set of question-answer combinations to generate a fine-tuned language model (e.g., the fine-tuned version of the second language model 124). The language model may be fine-tuned to generate the fine-tuned language model by modifying one or more weights and/or one or more biases of the language model. For example, a loss associated with the language model may be determined based upon a loss function. The one or more weights and/or the one or more biases may be modified to reduce and/or minimize the loss. At 210, a query (e.g., the first query) may be received from a client device (e.g., the first client device 100). At 212, a response (e.g., the first response) to the query may be generated using the fine-tuned language model.

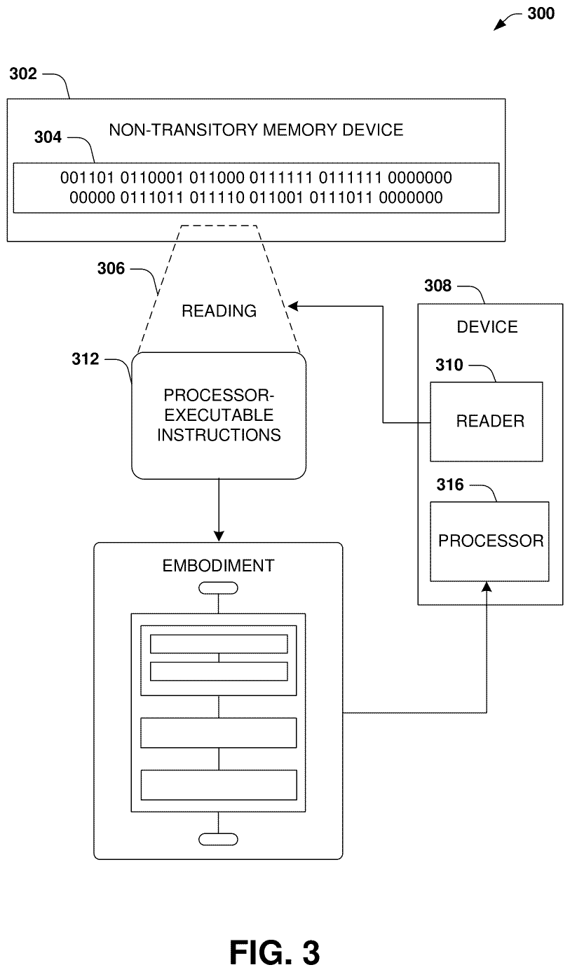

FIG. 3 is an illustration of a scenario 300 involving an example non-transitory machine readable medium 302. The non-transitory machine readable medium 302 may comprise processor-executable instructions 312 that when executed by a processor 316 cause performance (e.g., by the processor 316) of at least some of the provisions herein. The non-transitory machine readable medium 302 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 302 stores computer-readable data 304 that, when subjected to reading 306 by a reader 310 of a device 308 (e.g., a read head of a hard disk drive, or a read operation invoked on a solid-state storage device), express the processor-executable instructions 312. In some embodiments, the processor-executable instructions 312, when executed cause performance of operations, such as at least some of the example method 200 of FIG. 2, for example. In some embodiments, the processor-executable instructions 312 are configured to cause implementation of a system, such as at least some of the example system 101 of FIGS. 1A-1I, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
identifying a set of content items;
determining intent labels associated with the set of content items;
determining sentiments associated with the set of content items;
using a first language model to generate a set of question-answer combinations based upon the intent labels and the sentiments, wherein each question-answer combination of the set of question-answer combinations comprises a question and an answer to the question;
fine-tuning, based upon the set of question-answer combinations, a second language model to generate a fine-tuned language model;
receiving, from a client device, a query; and
generating, using the fine-tuned language model, a response to the query.

2. The method of claim 1, comprising:
generating a prompt based upon at least one of a sentiment associated with a content item of the set of content items, one or more intent labels associated with the content item, or the content item; and
submitting the prompt to the first language model, wherein the set of question-answer combinations is generated by the first language model in response to the prompt.

3. The method of claim 2, wherein determining the intent labels associated with the set of content item comprises:
analyzing data associated with the content item to determine a primary intent associated with the content item and a secondary intent associated with the content item, wherein the one or more intent labels comprise a first intent label indicative of the primary intent and a second intent label indicative of the secondary intent.

4. The method of claim 1, comprising:
grouping the set of content items into a plurality of groups based upon at least one of the intent labels associated with the set of content items or the sentiments associated with the set of content items, wherein:
the first question-answer combination of the set of question-answer combinations is generated based upon a first group of content items of the plurality of groups; and
a second question-answer combination of the set of question-answer combinations is generated based upon a second group of content items of the plurality of groups.

5. The method of claim 1, comprising:
accessing one or more internet resources;
extracting content from the one or more internet resources; and
generating a content item of the set of content items based upon the content.

6. The method of claim 5, wherein the content comprises at least one of:
user feedback;
one or more messages of a chat;
social media content; or
an article.

7. The method of claim 1, comprising:
prior to receiving the query from the client device, receiving a second query from a second client device;
generating, using the second language model, a second response to the second query; and
storing chat data comprising at least one of the second query or the second response, wherein a content item of the set of content items comprises the chat data.

8. The method of claim 1, wherein a content item of the set of content items comprises at least one of:
call data of one or more calls; or
chat data of one or more chats.

9. The method of claim 1, comprising:
displaying at least one of a search interface or a chat interface on a client device, wherein the query is received from the client device via at least one of the search interface or the chat interface; and
providing the response for display on at least one of the search interface or the chat interface.

10. The method of claim 1, wherein at least one of:
determining the intent labels associated with the set of content items is performed using a first transformer model; or
determining the sentiments associated with the set of content items is performed using a second transformer model.

11. A non-transitory computer-readable medium storing instructions that when executed perform operations comprising:
identifying a set of content items;
determining at least one of intent labels associated with the set of content items or sentiments associated with the set of content items;
using a first language model to generate a set of question-answer combinations based upon at least one of the intent labels or the sentiments, wherein a first question-answer combination of the set of question-answer combinations comprises a first question and a first answer to the first question;
fine-tuning, based upon the set of question-answer combinations, a second language model to generate a fine-tuned language model;
receiving, from a client device, a query; and
generating, using the fine-tuned language model, a response to the query.

12. The non-transitory computer-readable medium of claim 11, the operations comprising:
generating a prompt based upon at least one of a sentiment associated with a content item of the set of content items, one or more intent labels associated with the content item, or the content item; and
submitting the prompt to the first language model, wherein the set of question-answer combinations is generated by the first language model in response to the prompt.

13. The non-transitory computer-readable medium of claim 12, wherein determining the intent labels associated with the set of content item comprises:
analyzing data associated with the content item to determine a primary intent associated with the content item and a secondary intent associated with the content item, wherein the one or more intent labels comprise a first intent label indicative of the primary intent and a second intent label indicative of the secondary intent.

14. The non-transitory computer-readable medium of claim 11, the operations comprising:
grouping the set of content items into a plurality of groups based upon at least one of the intent labels associated with the set of content items or the sentiments associated with the set of content items, wherein:
the first question-answer combination of the set of question-answer combinations is generated based upon a first group of content items of the plurality of groups; and
a second question-answer combination of the set of question-answer combinations is generated based upon a second group of content items of the plurality of groups.

15. The non-transitory computer-readable medium of claim 11, the operations comprising:
accessing one or more internet resources;
extracting content from the one or more internet resources; and
generating a content item of the set of content items based upon the content.

16. The non-transitory computer-readable medium of claim 15, wherein the content comprises at least one of:
user feedback;
one or more messages of a chat;
social media content; or
an article.

17. The non-transitory computer-readable medium of claim 11, the operations comprising:
prior to receiving the query from the client device, receiving a second query from a second client device;
generating, using the second language model, a second response to the second query; and
storing chat data comprising at least one of the second query or the second response, wherein a content item of the set of content items comprises the chat data.

18. The non-transitory computer-readable medium of claim 11, wherein a content item of the set of content items comprises at least one of:
call data of one or more calls; or
chat data of one or more chats.

19. A computer comprising:
a processor coupled to memory, the processor configured to execute instructions from the memory to perform operations comprising:
identifying a set of content items;
determining at least one of intent labels associated with the set of content items or sentiments associated with the set of content items;
using a first language model to generate a set of question-answer combinations based upon at least one of the intent labels or the sentiments, wherein a first question-answer combination of the set of question-answer combinations comprises a first question and a first answer to the first question;
fine-tuning, based upon the set of question-answer combinations, a second language model to generate a fine-tuned language model;
receiving, from a client device, a query; and
generating, using the fine-tuned language model, a response to the query.

20. The computer of claim 19, the operations comprising:
generating a prompt based upon at least one of a sentiment associated with a content item of the set of content items, one or more intent labels associated with the content item, or the content item; and
submitting the prompt to the first language model, wherein the set of question-answer combinations is generated by the first language model in response to the prompt.
